(19) United States
(12) Patent Application Publication
(10) Pub. No.: US 2021/0364820 A1
(43) Pub. Date: Nov. 25, 2021

(54) Interchangeable Eyewear

(71) Applicants: Juanita Perry, Nashville, NC (US); Michael Perry, Lillington, NC (US)

(72) Inventors: Juanita Perry, Nashville, NC (US); Michael Perry, Lillington, NC (US)

(21) Appl. No.: 17/172,154

(22) Filed: Feb. 10, 2021

Related U.S. Application Data
(60) Provisional application No. 63/028,932, filed on May 22, 2020.

(51) Int. Cl. G02C 5/00; G02C 5/14; G02C 5/20

(52) U.S. Cl. CPC G02C 5/006; G02C 2200/08; G02C 5/20; G02C 5/143

(57) ABSTRACT

The present invention relates to a kit for creating personalized eyewear, such as eyeglasses, sunglasses and the like, that allow the user to alternate temples components, ear supports, lenses, etc. with a frame to create eyewear having different colors and/or styles. Each of the frame, the left and the right ear supports, the left and the right temple components, and the lenses connect to one another by one of a magnet, a clip, a snap, a clasp, a screw, an interference fit, and an interlocking frictional connector.

### CROSS-REFERENCE TO RELATED APPLICATION

The present application claims priority to, and the benefit of, U.S. Provisional Application No. 63/028,932, which was filed on May 22, 2020 and is incorporated herein by reference in its entirety.

### BACKGROUND

The present invention relates generally to the field of eyewear. More specifically, the present invention relates to eyeglass, sunglass and protective goggle frames with metal or plastic detachable arms or supports that can be easily removed, and replaced with alternate arms or supports. The arms are easily snapped to the base of the eyewear frame, and enable users to customize their frames with different styles and colors without having to purchase multiple frames. In one embodiment, the device is comprised of a relatively thin plastic covering that fits on the arms at each detachable location along the frame. In another embodiment, the invention also allows for the user to quickly and efficiently change the lens of the eye wear. Accordingly, the present specification makes specific reference thereto. However, it is to be appreciated that aspects of the present invention are also equally useable with other like applications, devices and methods of manufacture.

By way of background, eyewear, also commonly referred to as eyeglasses, spectacles, shades, goggles and the like, is commonly worn by individuals for fashion, protection, and to address vision related issues. For example, prescription or corrective eyeglasses are typically used to correct vision deficiencies, such as nearsightedness (myopia), farsightedness, astigmatism, presbyopia and others, and can dramatically improve the wearer's vision. Sunglasses or shades are a type of eyewear that uses shaded, tinted, or light polarized lenses that provide protection to the user from bright visible light, and even ultraviolet light. Other types of eyewear include protective eyewear, sporting eyewear, etc., wherein each type typically has specific lens' properties to provide a certain vision characteristic or attribute.

Eyewear is typically comprised of several different components. For example, two lens frame portions are typically located in front of the user's eyes, and may be connected by a bridge that extends over the bridge of the user's nose to provide support for the lenses. Nose pads may also be located between the lenses, near the bridge or on part of the frame holding the lenses. The lenses are also typically surrounded by a frame, although the lenses may be all or partially frameless. A hinge connects the frame or lenses to two temple pieces, also known as arms or supports. When worn, the arm supports extend back from the user's face and towards the ears. Each arm typically further comprises or is attached to an earpiece, which at least partially wraps around the user's ear and reduces the likelihood that the eyewear will fall off if the user looks downward.

Oftentimes, an individual has one, two or even multiple pairs of eyeglasses, which are worn on a regular basis. The frame, bridge, arms, and earpieces of the various eyeglasses may be decorative or ornamental, such as colored or having a pattern, logo or design. The eyeglasses may be worn for different purposes such as reading, driving, fashion or other reasons. Further, nowadays the style of the lens, frame and arms is considered a fashion statement and eyeglasses have become a common accessory to individuals' wardrobes. Users may often purchase a plurality of eyeglasses and sunglasses, each having a different style and/or color, as needed to match, for example, a particular outfit or other attire.

Additionally, designer eyewear can be exceptionally expensive due to its connection with a particular trademark or fashionable brand, and is oftentimes sought after by the consumer looking to make an impactful fashion or social statement. Because of this need to match eyewear to clothing and wardrobe, indoor and outdoor venues, for work purposes, and to correct a vision issue, a user's eyewear collection may become quite large and, in turn, be expensive to acquire and maintain.

For example, oftentimes an individual may want to wear a particular pair of glasses or sunglasses having a specific color and/or shape for aesthetic purposes or the like. Because such eyewear is typically sold as a whole or single unit, the individual must purchase, and then store and maintain, the desired eyewear. Inevitably, this adds a financial burden on the user if they wish to have more than one or two pairs of glasses. Further, upon acquisition, the user must then store the various sets of eyewear to protect his or her investment and to maintain the collection. Users who travel must also then transport the multiple different pairs of eyewear while during so, and risk leaving a desired pair of eyewear behind. Additionally, because such eyewear is unitary in its construction, if a portion of the eyewear becomes damaged (e.g., an arm breaks off), the entire unit must typically be replaced.

Attempts have been made in the prior art to create eyeglasses with removable or replaceable portions. However, assemblies of the past are inefficient and do not provide a simple, effective way to change the entire look of the eyeglasses. More specifically, such eyewear assemblies oftentimes require an optician and/or specialized tools to replace the desired part, which may not always be available or affordable. While other users may attempt to make the repair themselves, most are not educated in optics or skilled in repairing eyeglasses and can easily make mistakes while interchanging the parts of the eyewear assembly. Further, if performed incorrectly, the attempted repairs could result in additional damage to the eyewear and require its disposal.

Therefore, there exists a long felt need in the art for eyewear, such as eyeglasses, sunglasses and the like, having interchangeable temples, side arms, or supports that allow a user to selectively change the look of the eyewear at their convenience, and to make quick and easy repairs to the eyewear when damaged. There is also a long felt need in the art for eyewear having removable arm portions to allow the user to alternate arms to create different styles, and to change the color of the eyewear to suit user need and/or preference. Additionally, there is a long felt need in the art for eyewear comprising a unitary frame structure that can be easily attached and detached to different temples or support arms, and that enables a user to interchange the lenses without the use of mechanical tools or equipment, or the assistance of an optician. Moreover, there is a long felt need in the art for eyewear having removable temples that have a pop-in design to easily snap in for assembling and disassembling. Finally, there is a long felt need in the art for eyewear that enables a user to customize his or her frames with different styles and colors, that is relatively inexpensive to manufacture, and that is both safe and easy to use.

The subject matter disclosed and claimed herein, in one embodiment thereof, comprises an interchangeable eyewear assembly having a frame portion with a lens receiving area. The frame has a base on the side of each frame portion, each base having a slot to detach and attach sidearms, supports or temples. The sidearms are attached or detached using a pop-in design, snap or interference fit. The sidearms may have an additional detachable location to add temple tips of different designs or colors, and the temple portion may also have a logo, design or other embellishment made from a holographic material that changes colors when turned at different angles. The interchangeable eyewear assembly of the present invention also allows for the release of lenses from the bottom of the frame (which is open) to interchange with different colored lenses if so desired.

In this manner, the interchangeable eyewear assembly of the present invention accomplishes all of the forgoing objectives, and provides an easy, convenient and cost-effective solution to creating customized and different eyewear according to the preferences of the individual user. The interchangeable eyewear assembly of the present invention is also user friendly inasmuch as it is relatively inexpensive to customize one's eyewear, and does not require any external tools or specialized expertise to interchange the eyewear's temples, support, arms and/or lenses to create the desired eyewear.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an eyewear assembly having a frame portion and lens receiving area. The frame has a base on the side of each frame portion, with each base having a slot to detach and attach sidearms, supports or temples. The sidearms are attached or detached to the base portion using a pop-in design, snap or interference fit. Additionally, the sidearms may have an additional detachable location along their length so that the user can interchange temple tips of different design or color, or other components to stylize the eyewear. The temple or sidearms may also have a company logo made from a holographic material that changes colors when turned at different angles. The eyewear assembly of the present invention also allows for the release of lenses from the bottom of the frame, which is open, to interchange with different colored lenses if desired.

In a further embodiment of the present invention, an interchangeable frame for eyeglasses comprising first and second lenses is disclosed. The interchangeable frame is comprised of a left lens frame, a right lens frame, a left temple attached to a base of the left lens frame, and a right temple attached to a base of the right lens frame. The left temple and the right temple are selectively attached and detached from the corresponding base through, for example, a snap fit, an interference fit, a pop-in design, a magnet, a screw, or the like. Additionally, the first temple or sidearm portion has a detachable location to add an interchangeable temple piece and the second temple or sidearm portion has a detachable location to add an interchangeable temple piece. The interchangeable temple components may include magnets and/or screws to attach and/or detach from the slots to interchange the temple portions of the eyewear of the present invention.

In yet a further embodiment of the present invention, an eyewear having interchangeable lenses is disclosed. More specifically, the eyewear comprises a first frame portion with a first half rim forming a first brow bar, and a second frame portion having a second half rim forming a second brow bar. The first frame portion contains a removable first lens, and the second frame portion contains a removable second lens. The removable first lens and the removable second lens are configured to be replaced by a pair of different eye lens, which are attached to the first frame portion and the second frame portion. The attachment of the lens portions to the frame portions may be by any of the attachment means disclosed herein.

In yet another embodiment of the present invention, a method of exchanging lenses in an eyewear system is disclosed and comprises the step of initially removing a first lens from a first half rim frame portion, and then removing a second lens from a second half rim frame portion. Next, the removed first lens is replaced by attaching a secondary first lens in the first half rim frame portion, and the removed second lens is replaced by attaching a secondary second lens in the second half rim frame portion. The attachment of the lens portions to the frame portions may be by any of the attachment means disclosed herein.

In yet another embodiment of the present invention, an interchangeable eyewear kit is provided. The kit includes a first lens, a second lens, a lens frame portion, a plurality of first temple components, a plurality of second temple components, a plurality of first temple pieces, and a plurality of second temple pieces. Accordingly, a user may selectively use a first temple from the plurality of first temple components, a second temple from the plurality of second temple components, a first temple piece from a plurality of first temple pieces, and a second temple piece from the plurality of the second temple pieces to customize their frames with different styles and/or colors. The temple components may have a logo, brand, design, trademark or the like, and the same may be made from a holographic material that changes colors when turned at different angles. The components of the present invention may also be wrapped with color changing graphic films such as those marketed under the brand name ORAFOL®. The films may be made of vinyl, plastics or other flexible materials. Other possibilities include micro-prismatic tape, such as that marketed under the brand name REFLEXITE®, which uses microprisms. Micro prisms suitable for use with the present invention include prisms having a height of about 60 μm and side of about 175 μm. Further, the frame and temple are preferably made from a durable plastic, an alloy such as nickel, tin, bronze, etc., or metals such as titanium, zinc, copper, aluminium, gold, silver, etc. The attachment of the various temple pieces and/or components may be by any of the attachment means disclosed herein.

In a still further exemplary embodiment of the present invention, a combination eyeglass and personalization kit is disclosed. The kit includes a set of eyeglasses having a frame, and first and second lenses held within the frame and left and right sides, with each of the left and right sides having temples components and ear supports. The kit further comprises a plurality of left and right temple components and left and right ear supports. Each of the left and right temple components and left and right ear supports are interchangeable with the temple components and ear supports of the frame. The left and right temple components have first and second sides with each of the first sides provided with one of a color, logo, name, trademark or design, and the second side provided with at least a color. Each of the left and right temple components and left and right ear supports are removably connected to one another and to the frame by any of the attachment means disclosed herein.

In a yet still further exemplary embodiment of the presently described invention, a personalized set of eyewear is disclosed. The eyewear includes a frame having first and second lenses, left and right sides, a connection point on each of the left and right sides, a left temple component, a right temple component, a left ear support, and a right ear support. Each of the left and right temple components have a first side and a second side, with the first side of each of the left and right temple components having one of a color, logo, indicia or trademark, and the second side of each of the left and right temple component having no logo, indicia or trademark. Each of the left and right temple components further comprise first and second ends and a connection point, wherein the left ear support connects to the left temple component at the first end of the left temple component and the left temple component connects to the left side of the frame at the second end of the left temple component, and further wherein the right ear support connects to the right temple component on the first end of the right temple component and connects to the right side of the frame at the second end of the right temple component.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective and partially exploded view of one potential embodiment of the interchangeable eyewear of the present invention in accordance with the disclosed architecture;

FIG. 2 illustrates a perspective view of one potential embodiment of the interchangeable eyewear of the present invention in accordance with the disclosed architecture;

FIG. 3a illustrates a perspective front view of one potential embodiment of the interchangeable eyewear of the present invention in accordance with the disclosed architecture;

FIG. 3b illustrates a perspective front view of one potential embodiment of the left and right replacement lenses of the interchangeable eyewear of the present invention in accordance with the disclosed architecture;

FIG. 4 illustrates a perspective and partially exploded view of an alternative embodiment of the interchangeable eyewear of the present invention in accordance with the disclosed architecture;

FIG. 5 illustrates a perspective view of one potential embodiment of the interchangeable eyewear of the present invention in accordance with the disclosed architecture and being worn by a user;

FIG. 6 illustrates a perspective view of a plurality of interchangeable temple portions for inclusion in one potential embodiment of the interchangeable eyewear kit of the present invention in accordance with the disclosed architecture; and

FIG. 7 illustrates a perspective view of a plurality of different interchangeable eyewear that may be created from one potential embodiment of the interchangeable eyewear kit of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention or do not limit the scope of the invention. Additionally, an illustrated embodiment need not have all the aspects or advantages shown. Thus, in other embodiments, any of the features described herein from different embodiments may be combined.

As noted above, there is a long felt need in the art for eyewear having interchangeable temples, sidearms, lenses, and/or supports that allow a user to selectively change the design and/or color of the eyewear at his or her convenience, and to make quick and easy repairs to the eyewear when a particular component is damaged. There is also a long felt need in the art for eyewear having a unitary frame structure that can be easily attached to and detached from different temples or support arms, and that enables a user to interchange the lenses without the use of mechanical tools or equipment, or the assistance of an optician. Finally, there is a long felt need in the art for eyewear having removable temples and other interchangeable components that have a pop-in or interference fit means or design for easily assembling and disassembling of the various eyewear components, thereby enabling a user to quickly and efficiently customize his or her eyewear.

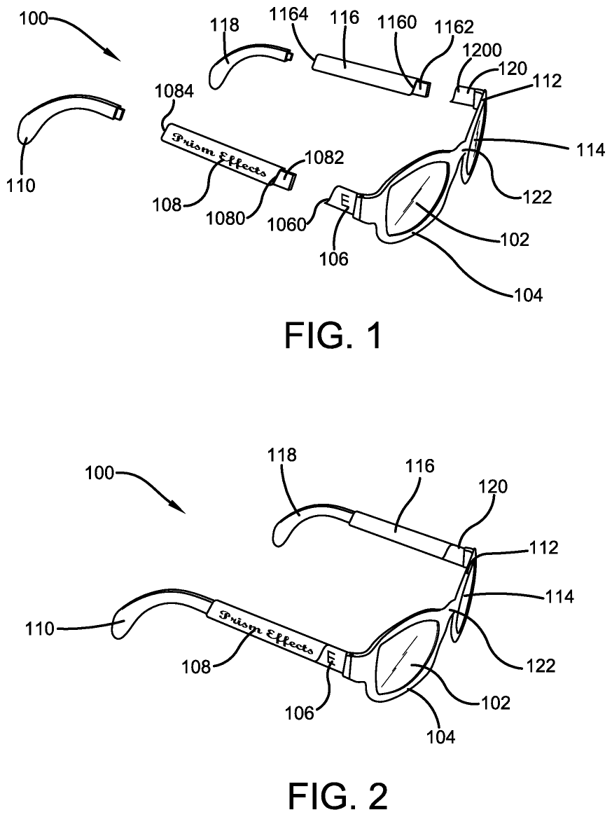

Referring initially to the drawings, FIG. 1 illustrates a perspective and partially exploded view of one potential embodiment of the interchangeable eyewear 100 of the present invention in accordance with the disclosed architecture. More specifically, the eyewear assembly 100 comprises a left lens frame 112, a right lens frame 104, a left lens 114, a right lens 102, a left temple 116 removably attached to a left base 120 of the left lens frame 112, and a right temple 108 removably attached to a right base 106 of the right lens frame 104. The left temple 116 and the right temple 108 may be selectively attached and detached from the base 120, 106 through any of a snap fit, clip, pop-in design, magnet, screw, interference fit, frictional interlocking components, etc. For additional customization options, the right temple 108 may further comprise a slot or opening therein into which a right ear piece 110 can be removably attached, as best shown in FIGS. 1 and 2. Similarly, the left temple 116 may also comprise a slot or opening in which a left ear piece 118 can be removably attached.

As noted above, the temple portions 116, 108 may be removably attached to the bases 120, 106 respectively, to allow a user to customize the design, shape and/or color of the eyewear 100. More specifically, said attachments may be made through a variety of different attachment means including, without limitation, a snap fit, a clip, a pop-in design, a magnet, a screw, an interference fit, frictional interlocking male/female components, etc. Similarly, the ear pieces 110, 118 may also be removably attached to the slots of temple 108, 116 respectively using similar means. In each instance, the attachment means should be secure enough to overcome everyday forces caused by the user wearing the eyewear 100 so that the connection is not unintentionally broken, but not so secure as to prevent the user from freely and quickly interchanging the various components of the eyewear 100.

By way of example, to attach the right temple 108 to the right base 106, the right base 106 receives a right arm 1082 extending from the right temple 108 into a receiver (e.g., an opening or slot) of the right base 106, and the edge 1060 of the right base 106 and a proximal right edge 1080 of the right temple 108 may be magnetically or frictionally secured together to form a secure connection. As best shown in FIG. 1, the right arm 1080 has a diagonally shaped interconnecting piece, positioned at an angle ranging from 30° to 60° from the bottom of arm 1080 (the ear pieces and bases may have a similar angled connector), that slides into a corresponding slot 1060, which has a correspondingly shaped angle to form a complete mating alignment. In a similar manner, a distal right edge 1084 of the right temple 108 may receive a right ear piece 110 to form a complete means to wear the eyewear 100. Similarly, to attach the left temple 116 to the left base 120, the left base 120 receives the left arm 1162 extending from the left temple 116 into a receiver of the left base 120, and the left edge 1200 of the left base 120 and the proximal left edge 1160 of the left temple 116 are magnetically or frictionally secured together to form a secure connection. Likewise, the distal left edge 1164 of the left temple 116 may also receive the left ear piece 118 to form a complete means to wear the eyewear 100 if the same also includes interchangeable ear pieces 110, 118. In one embodiment, the temple arms 1082, 1162 are sufficiently shaped and sized to fit within the slots in the bases 106, 120 respectively and form a friction or interference therewith.

The bases 120, 106 are coupled to and extend from the frame 122. Therefore, the magnetic, frictional or other interlocking connection mechanism inhibits removal of right temple 108 from the right base 106 and, similarly, removal of left temple 116 from the left base 120, and secures the temples or sidearms to the eyeglass frame 122. Nonetheless, the magnetic, frictional or other interlocking connections can be embedded, recessed, positioned flush with or raised from the surface to which, or in which, the member is secured.

In this manner, temples 108, 116 and ear pieces 110, 118 may be interchanged freely and as desired by the user on each side of the frame 122, thereby enabling the user to make repairs to the eyewear 100 or to simply change the overall appearance thereof. Further, the temples 108, 116 may have logo, brand, trademark, color, font, design, etc., for example, to represent a particular company, team, retailer, etc. These embellishments may be made from a holographic material that changes colors when turned in different angles and directions, or other films which use individual microcubes or prisms to direct reflected light back to the viewer. The interchangeability of the temples, ear pieces and the like enable a person who wears eyewear to have several sets of eyewear without the need for more than one set of frames and/or lenses.

FIG. 2 illustrates a perspective view of one potential embodiment of the fully assembled interchangeable eyewear 100 of the present invention in accordance with the disclosed architecture. More specifically, the left temple 116 and the right temple 108 are secured to the left base 120 and right base 106 respectively. Further, the right ear piece 110 is secured and attached to right temple 108, and the left ear piece 118 is secured and attached to left temple 116. The bases 106, 120 may be pivotally coupled to the frame 122 such that the right temple 108, while connected to right base 106, may be pivoted relative to the frame 122 in a conventional manner. Similarly, the left temple 116, while connected to left base 120, may be pivoted relative to the frame 122 in a conventional manner.

It should be appreciated that the various components of the eyewear 100 of the present invention are dimensioned to allow a user to conveniently wear the eyewear 100 based on the user's physical attributes. By way of example, the temples 116, 108 of the eyewear 100 should be long enough so that the position of bending of the ear pieces 118, 110 downward at about a 45-degree angle is at a point just beyond the top of the particular's ears, and wide enough so that the temple 116, 108 conforms closely to the contour of the user's head. Accordingly, in one embodiment, the cumulative length of a select one of temples 116, 108 and a select one of ear pieces 118, 110 is preferably in the range of 120 to 180 mm. This keeps the frame securely in place on the user with minimal, if any, pressure on the user's ears. In some preferred embodiments of the present invention, the eyewear 100 and its various components are comprised of a molded plastic, a rigid plastic or a semi-rigid plastic.

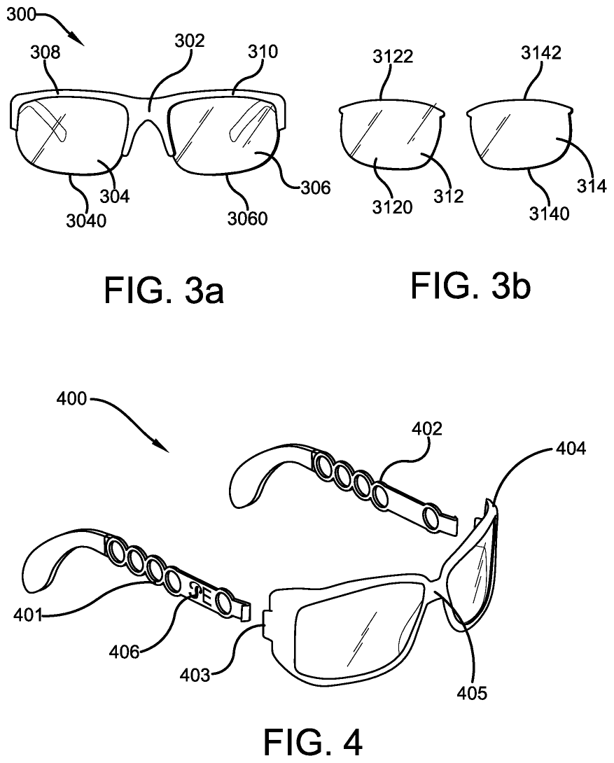

FIG. 3a illustrates a perspective front view of one potential embodiment of the interchangeable eyewear 100 of the present invention in accordance with the disclosed architecture. More specifically, FIG. 3a illustrates a half rim eyewear 300, wherein a left lens 306 is attached to a left half rim frame portion 310, and a right lens 304 is attached to the right half rim frame portion 308. The lenses 306, 304 are preferably friction fitted to the half rim frames 310, 308 with top edges of the lenses attached to the half rim frame portions 310, 308, and wherein the bottom edge of the lenses, such as bottom edge 3060 of the left lens 306 and bottom edge 3040 of the right lens 304, are free and are not directly attached to the frame 302. The lenses 304, 306 can be easily removed or disengaged from the circumferential edge of the frame portions 308, 310 by a user without using any tool or equipment. More specifically, the user may apply a gentle force to separate the lens 304, 306 from the rim to remove the lenses for replacement with other lenses of different characteristics and/or colors.

For example, FIG. 3b illustrates a perspective front view of one potential embodiment of the left and right replacement lenses 314, 312 of the interchangeable eyewear 100 of the present invention in accordance with the disclosed architecture. Right replacement lens 312 has a bottom edge 3120 and a top edge 3122, and left replacement lens 314 has a bottom edge 3140 and a top edge 3142. The replacement lenses 312, 314 are attached to the frame 302 as per the preferences of the user to customize the lenses associated with the frame 302. More specifically, the original lenses 304, 306 are replaced, and the replacement lenses 312, 314 are attached to the half rim frame portions 308, 310 by inserting the lenses into a groove on the frame, or using any other fastening mechanism, such as a magnetic connection, pop-in, clip, frictional fit design or snap-in/out connection. In this manner, the user is provided with a means for easily and quickly replacing the lenses 304, 306 in an eyewear frame 302 by simple snap in or magnetic engagement. Accordingly, the right replacement lens 312 and the left replacement lens 314 may take many forms, shapes, colors, etc. Further, any of lenses 304, 306 and/or replacement lenses 312, 314 may be prescription lenses, over the counter lenses, transparent lenses, shaded lenses, or any other type of lens known in the art, now or in the future, and multiple pairs of interchangeable lenses 312, 314 of varying characteristics, colors or purposes may be used with the same eyewear frame.

Interchangeable replacement lenses 312, 314 may be used to provide various functionalities to eyewear 300. For example, eyewear 300 may be provided for use with multiple pairs of interchangeable lenses 312, 314 configured, for example, as 3D lenses for viewing 3D images, darkening lenses for sunglasses functionality, or shaded lenses, magnifying lenses for assistance in reading, transparent lenses, protective lenses and/or other lenses of any desired functionality. A user may remove one pair of interchangeable lenses 312, 314 and replace them with another pair of interchangeable lenses for different purposes, as desired.

FIG. 4 illustrates a perspective and partially exploded view of an alternative embodiment of the interchangeable eyewear 400 of the present invention in accordance with the disclosed architecture. More specifically, the full frame eyewear assembly 400 has a frame 405 having a left frame extender 404 and a right frame extender 403, wherein each of left frame extender 404 and the right frame extender 403 have a slot or opening therein to receive a portion of the temple arms 401, 402. Each of the temple arms 401, 402 is a single body or unitary structure with no other detachable portion or part. Further, each of the temple arms 401, 402 may have a logo, signature, trademark, or other design 406 to enhance the market value and aesthetic appearance of the eyewear assembly 400.

The right temple arm 401 may be removably but securely attached to the right frame extender 403 via any of the attachment means discussed herein including, without limitation, a magnetic connector, screw, snap, clip, frictional components, male and female interlocking parts, pop-in design, friction or interference fit, etc. securely connects the right temple arm 401 to the right frame extender 403. Likewise, the left temple arm 402 may be removably but securely attached to the left frame extender 404 in a similar manner.

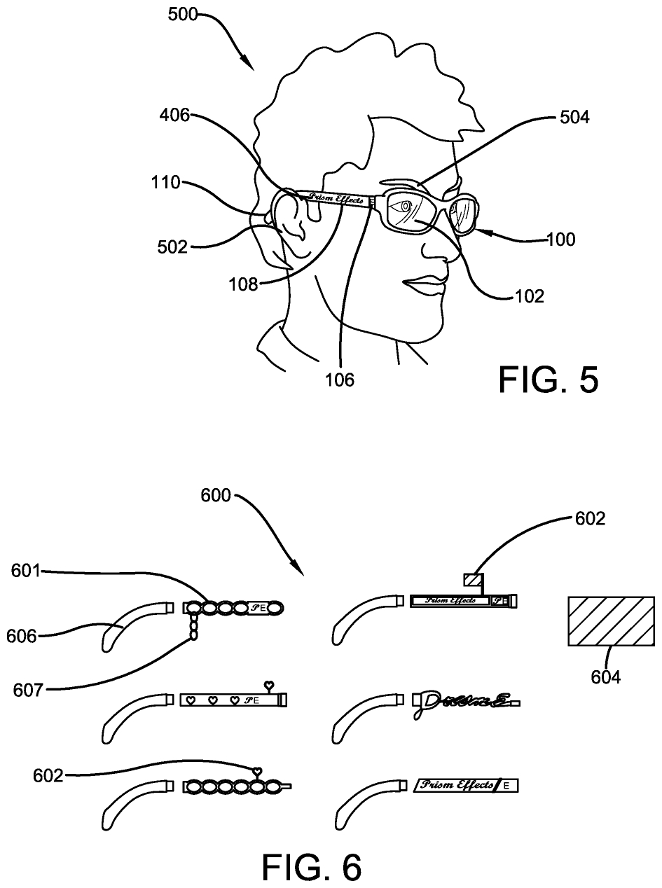

FIG. 5 illustrates a perspective view of one potential embodiment of the interchangeable eyewear 100 of the present invention in accordance with the disclosed architecture and being worn by a user 500. More specifically, a user 500 may select or compile the various components of the eyewear assembly 100 to suit user need and/or preference with respect to such attributes or parameters such as design, color, lens type, etc. When worn, the lenses of eyewear 100 are positioned in front of the eyes of user 500, and the right temple 108 portion rests gently on the user's right ear 502 with ear piece 110 bending at an angle behind the user's right ear 502 (a similar orientation is present on the left side of the user's head, but is not shown in the FIG.). The top portion of the right and left lens frame 104, 112 is generally in line with or just below the eyebrows 504 of the user 500. Further, a logo 406, name, trademark, design, etc. may be clearly visible when the eyewear 100 is worn by the user 500 to increase the aesthetic appearance of the eyewear 100.

FIG. 6 illustrates a perspective view of a plurality of interchangeable temple portions for inclusion in one potential embodiment of the interchangeable eyewear kit 600 of the present invention in accordance with the disclosed architecture. More specifically, kit 600 may be supplied with a plurality of temple components 601 of various colors and designs for the user to choose from, and that can be attached to the eyewear frame. The various temple components 601 may be of different colors, shapes and designs to personalize the eyewear depending on the clothes, occasion, style and mood of the user. The temple components 601 may be engaged or attached to the frame using a magnetic fastener, screw, nut, interconnecting element, or bolt or any other suitable attachment mechanism.

Likewise, the kit 600 may further comprise a plurality of different ear supports 605 or other stylizing components 602, which may include, without limitation, flags, hearts, balloons, etc. to further accessorize the eyewear 100. Other features may include chains 603, earrings 607, or the like. The various components 602, chains 603, earrings 607 and the like may be applied to the eyewear 100 by any of the attachment means described herein. In a further embodiment, the kit 600 may further comprise one or more sheets of color changing film, micro-prismatic films, colored graphics 604 and the like, which the user can use to change, and continue to provide stylistic elements to, the eyewear 100. In this manner, the user is able to utilize the kit 600 to mix and match temple components 601, ear supports 605, flags, chains 603, earrings 607 and other color stylistic elements 602 to personalize and/or accessorize eyewear 100.

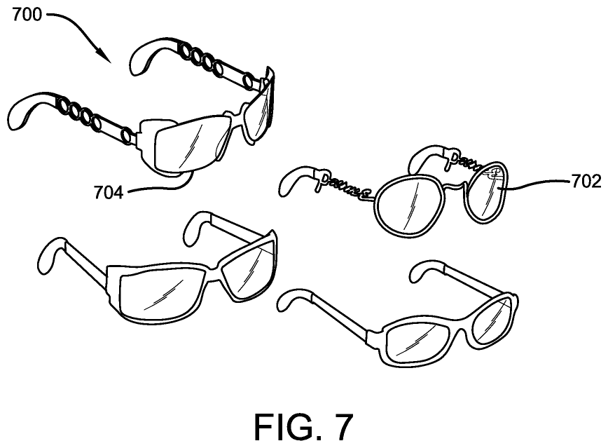

FIG. 7 illustrates a perspective view of a plurality of different interchangeable eyewear 700 that may be created from one potential embodiment of the interchangeable eyewear kit of the present invention in accordance with the disclosed architecture. More specifically, eyewear assemblies 700 enable diversity for eyewear users by offering unlimited possibilities for interchangeable temples and interchangeable lenses using a single kit that includes a central frame. Individuals who may have been self-conscious of wearing glasses can now color-coordinate their eyewear with their style, hair color, wardrobe, etc. It can be seen that relatively few interchangeable parts need to be purchased to allow a large number of permutations in style and shape of the eyewear.

The eyewear 100 of the present invention, including the frame, temples, and/or the lenses, may also be flexible to accommodate various sized users. In an embodiment, the temples may be generally inwardly pointing (i.e., in the direction of the head of the user), bend at various angles, or converge to wrap around a wearer's head and/or ears. In another embodiment, the temples may be flexible enough so that they are pushed outward by a wearer with a larger head.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For instance, the exterior shape and dimensions of the frame assemblies, temples, mechanical interlocks and magnetic interlocks can be any suitable shape or configuration, including the use of curved surfaces in the place of straight surfaces, and vice versa. It is also contemplated that various combinations or sub-combinations of the specific features and aspects of any of the many embodiments may be made and still fall within the scope of the invention.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “Eyewear”, “Eyewear with detachable arms”, “eyeglass” and “eyewear assembly are interchangeable and refer to the eyewear assembly 100 of the present invention. Likewise, “a lens” and “a pair of lenses” are used synonymously to include both the singular and the plural of one or more lenses to cover one or both eyes during a viewing experience. Similarly, “temple” or “sidearm” are used synonymously to include one or more temple attached to the frame using a fastening mechanism and resting comfortably on the ears to keep one's eyewear in place on the head and in front of the eyes.

Notwithstanding the forgoing, the interchangeable eyewear assembly 100 of the present invention can be of any suitable size and configuration as is known in the art without affecting the overall concept of the invention, provided that it accomplishes the above stated objectives. One of ordinary skill in the art will appreciate that the size, configuration and material of the interchangeable eyewear assembly 100 as shown in the FIGS. are for illustrative purposes only, and that many other sizes of the interchangeable eyewear assembly 100 are well within the scope of the present disclosure. Although the dimensions of the interchangeable eyewear assembly 100 are important design parameters for user convenience, the interchangeable eyewear assembly 100 may be of any size that ensures optimal performance during use and/or that suits user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations that fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An eyewear accessory kit comprising:
a plurality of ear pieces;
a plurality of lenses;
a plurality of temple pieces, wherein each of the plurality of temple pieces is removably attachable to at least one of the plurality of ear pieces and to a frame.

2. The eyewear accessory kit of claim 1 further comprising at least one sheet of a film for application to one or more of the plurality of ear pieces, the plurality of lenses and the plurality of temple pieces.

3. The eyewear accessory kit of claim 2, wherein the film is one of a color changing film, a holographic film and a micro-prismatic film.

4. The eyewear accessory kit of claim 3, wherein the micro-prismatic film has a micro-prism having a height of about 60 μm and a side of about 175 μm.

5. The eyewear accessory kit of claim 1, wherein each of the plurality of temple pieces have a first end and a second end, and further wherein the each of the first and second ends have an angled connector ranging from 30° to 60° relative to a bottom of each temple piece.

6. The eyewear accessory kit of claim 1, wherein each of the plurality of ear pieces have a connector end that is angled ranging from 30° to 60° relative to a bottom of each ear piece.

7. The eyewear accessory kit of claim 1, wherein the frame has left and right bases and each of the left and right bases has an angled connector ranging from 30° to 60° relative to a bottom of each base.

8. The eyewear accessory kit of claim 1, wherein each of the frame, the plurality of ear pieces and the plurality of temple pieces connect to one another by one of a magnet, a clip, a snap, a clasp, a screw, an interference fit, or an interlocking frictional connector.

9. The eyewear accessory kit of claim 1 further comprising a plurality of embellishments for use with at least one of the plurality of temple pieces, the plurality of ear pieces, and the plurality of lenses.

10. The eyewear accessory kit of claim 1, wherein the plurality of lenses include a magnifying lens, a shaded lens, a prescription lens, a protective lens and a transparent lens.

11. An interchangeable eyewear comprising;
a frame having a first lens, a second lens, a left side, a right side, and a connection point;
a left temple component;
a right temple component, wherein each of the left and right temple components have one of a color, a logo, an indicia or a trademark;
a left and right ear support with each of the left and right ear supports having an ear connection point; and
wherein the left ear support connects to the left temple component at a first end of the left temple component, and the left temple component connects to the left side of the frame at a second end of the left temple component, and the right ear support connects to the right temple component at a first end of the right temple component and connects to the right side of the frame at a second end of the right temple component.

12. The interchangeable eyewear of claim 11, wherein each of the ear connection points is an angled connection ranging from 30° to 60° relative to a bottom of the left or right temple component, respectively.

13. The interchangeable eyewear of claim 11, wherein the frame has a mating angled component to receive each an angled connection of the left and right temple components.

14. The interchangeable eyewear of claim 13, wherein each of the left and right ear supports have an angled connection point to receive the angled connection point of the left and right temple components.

15. The interchangeable eyewear of claim 11, wherein each of the frame, left and right ear supports and the left and right temple components connect to one another by one of a magnet, a clip, a snap, a clasp, a screw, an interference fit or an interlocking frictional connector.

16. The personalized set of eyeglasses of claim 11, wherein the first lens is selected from a group including a magnifying lens, a shaded lens, a prescription lens, a protective lens and a transparent lens.

17. The personalized set of eyeglasses of claim 11, wherein at least one of the left and right temple components comprise a color changing film, a holographic film or a micro-prismatic film.

18. An eyewear personalization kit comprising;
a pair of eyeglasses having a frame, a first lens, a second lens, a right and a left temple component, and a left and a right ear support;
a plurality of replacement lenses each interchangeable with the first or the second lens;
a plurality of replacement temple components each interchangeable with the left or the right temple component;
a plurality of replacement ear supports each interchangeable with the left or the right ear support, wherein each of the left and right temple components are removably connected to a respective one of the left and right ear supports on a first end of the left and right temple components and are removably connected to the frame on a second end of the left and right temple components.

19. The eyewear personalization kit of claim 18 further comprising at least one of a color changing film, a holographic film and a micro-prismatic film.

20. The eyewear personalization kit of claim 18, wherein each of the frame, the left and the right ear supports, and the left and the right temple components connect to one another by one of a magnet, a clip, a snap, a clasp, a screw, an interference fit, and an interlocking frictional connector.
